(19) United States
(12) Patent Application Publication
(10) Pub. No.: US 2017/0341916 A1
(43) Pub. Date: Nov. 30, 2017

(54) Prying Device

(71) Applicant: Yeng Ping Wong, Taichung City (TW)

(72) Inventor: Yeng Ping Wong, Taichung City (TW)

(21) Appl. No.: 15/439,992

(22) Filed: Feb. 23, 2017

(30) Foreign Application Priority Data
May 31, 2016 (TW) 105117093

(51) Int. Cl. B66F 15/00; B25G 1/00

(52) U.S. Cl. CPC B66F 15/00; B25G 1/00

(57) ABSTRACT

A prying device includes a one-piece body. The body includes first and second structural sections. The first structural section includes first and second surfaces and first and second lateral sides. The first and second surfaces are disposed oppositely. The first and second lateral sides are disposed oppositely and each extends from the first surface to the second surface. The second surface curves into a concave shape in a direction transverse to the axis. The second structural section includes third and fourth surfaces and third and fourth lateral sides. The third and fourth surfaces are disposed oppositely. The third and fourth lateral sides are disposed oppositely and each extends from the third surface to the fourth surface. The first and third surfaces are juxtaposed and on the same side of the body. The second and fourth surfaces are juxtaposed and on the same side of the body.

### BACKGROUND OF THE INVENTION

### 1. Field of the Invention

The present invention relates to a prying device, particularly, to a prying device that can withstand high stress tensile working loads.

### 2. Description of the Related Art

Taiwan publication. No. 200846271 shows a bar of a prying device including a first end coupling to a grip and a second end forming a working end adapted to insert underneath an object to be pried by the prying device, respectively. The bar includes a first section extending axially along an axis and a second section extending at an inclined angle relative to the axis. The working end includes the second section of the bar. The thickness of the second section of the bar is gradually reduced as it extends away from the first section and is flat, which facilitates insertion of the working end underneath the object to be pried.

When prying a heavy object with the prying device, the prying device is subject to high working loads, and the problem is that the bar can bend, or even worse, break from a stress concentration region.

The present invention is, therefore, intended to obviate or at least alleviate the problems encountered in the prior art.

### SUMMARY OF THE INVENTION

According to the present invention, a prying device includes a body being a one-piece structure. The body includes a first structural section and a second structural section connected to the first structural section axially along an axis. The first structural section has a longitudinal length determining a lever arm length of the prying device. The second structural section is adapted to insert underneath an object to be pried by the prying device. The first structural section includes first and second surfaces and first and second lateral sides extending lengthwise along the axis. The first and second surfaces are disposed oppositely. The first and second lateral sides are disposed oppositely and each extends from the first surface to the second surface. The second surface curves into a concave shape in a direction transverse to the axis. The second structural section includes third and fourth surfaces and third and fourth lateral sides extending lengthwise along the axis. The third and fourth surfaces are disposed oppositely. The third and fourth lateral sides are disposed oppositely and each extends from the third surface to the fourth surface. The first and third surfaces are juxtaposed and on the same side of the body. The second and fourth surfaces are juxtaposed and on the same side of the body.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is an objective of the present invention to provide a prying device that can withstand high stress tensile working loads.

It is a further objective of the present invention that the driving component and the coupling component are coupled to each other without a securing member, which includes an inner periphery abutting a periphery of one of the driving and coupling components and an outer periphery abutting a periphery of another of the driving and coupling components.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a prying device in accordance with a first embodiment of the present invention.

FIG. 2 is a partial, cross-sectional view of the first embodiment of the prying device.

FIG. 3 is a cross-sectional view taken along line 3-3 of FIG. 2.

FIG. 4 is a cross-sectional view taken along line 4-4 of FIG. 2.

FIG. 5 is a partial, cross-sectional view of a prying device in accordance with a second embodiment of the present invention.

FIG. 6 is a cross-sectional view taken along line 6-6 of FIG. 5.

### DETAILED DESCRIPTION OF THE INVENTION

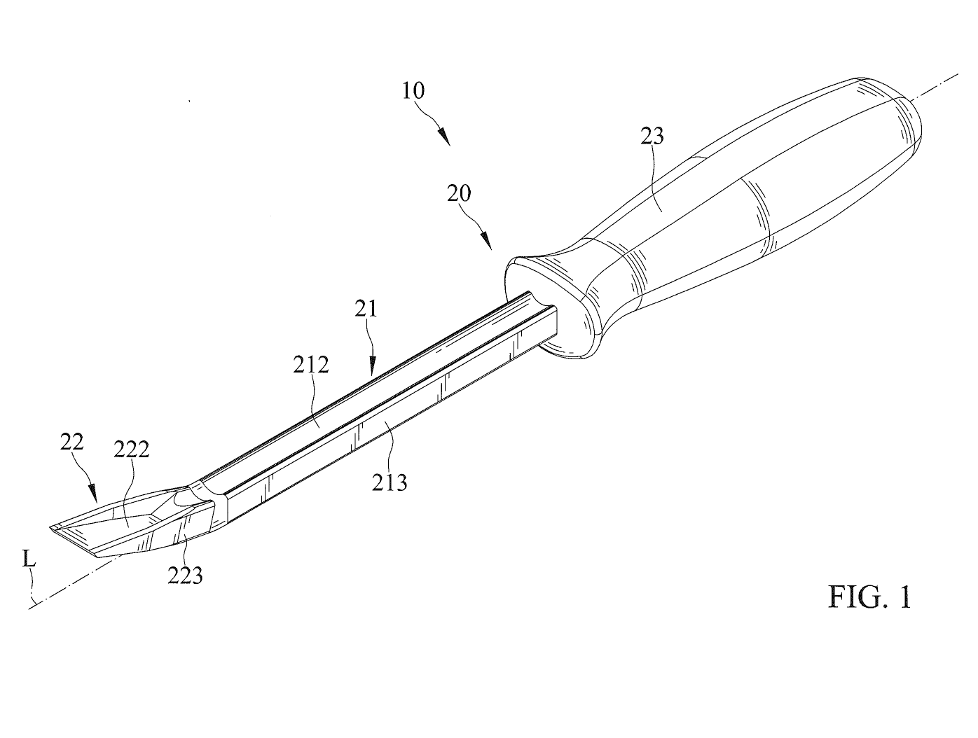

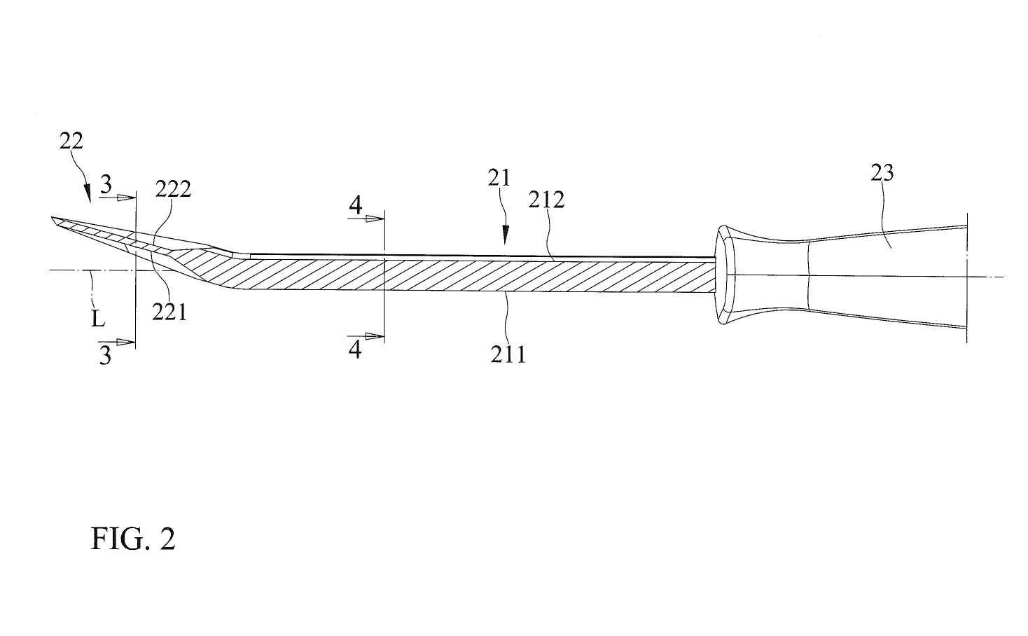

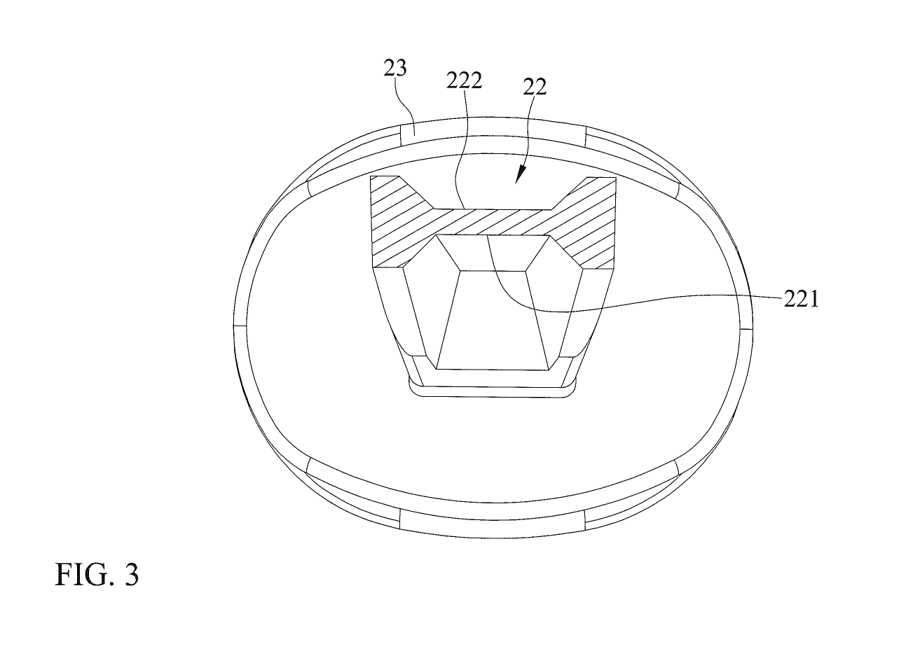

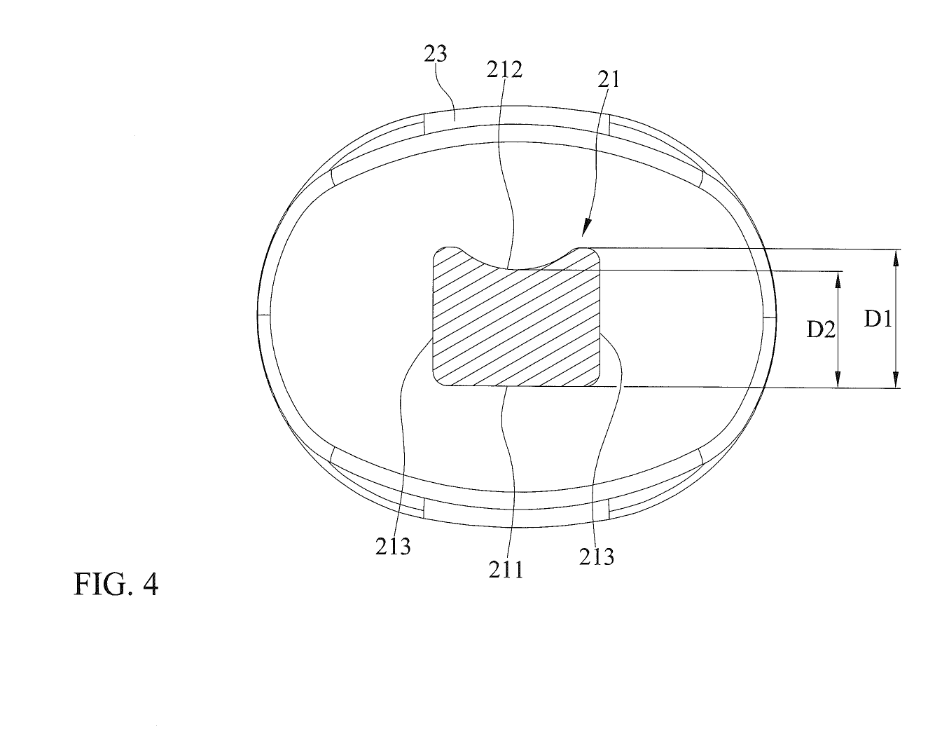

FIGS. 1 through 4 show a prying device 10 in accordance with a first embodiment of the present invention includes a body 20 being a one-piece structure. The body 20 includes a first structural section 21 and a second structural section 22. The second structural section 22 is connected to the first structural section 21 axially along an axis L.

The first structural section 21 has a longitudinal length determining a lever arm length of the prying device 10. The first structural section 21 includes first and second surfaces 211 and 212 and first and second lateral sides 213 extending lengthwise along the axis L. The first and second surfaces 211 and 212 are disposed oppositely. The first and second lateral sides 213 are disposed oppositely and each extends from the first surface 211 to the second surface 212. The first surface 211 is a flat level surface. The second surface 212 curves into a concave shape in a direction transverse to the axis L. The first and second lateral sides 213 are flat level surfaces. The first structural section 21 is quadrilateral in cross-section. The first and second surfaces 211 and 212 are spaced apart from one another in a thickness of the first structural section 21. The first structural section 21 has a first thickness D1 defining a maximum thickness thereof and a second thickness D2 defining a minimum thickness thereof respectively. The second thickness D2 is less than 0.9 times of the first thickness D1. The second thickness D2 is greater than 0.75 times of the first thickness D1.

The second structural section 22 is adapted to insert underneath an object to be pried by the prying device 10. The second structural section 22 includes third and fourth surfaces 221 and 222 and third and fourth lateral sides 223 extending lengthwise along the axis L. The third and fourth surfaces 221 and 222 are disposed oppositely. The third and fourth lateral sides 223 are disposed oppositely and each extends from the third surface 221 to the fourth surface 222. The first and third surfaces 211 and 221 are juxtaposed and on the same side of the body 20. The second and fourth surfaces 212 and 222 are juxtaposed and on the same side of the body 20.

The body 20 includes a bend between the first and second structural sections 21 and 22 and when the first structural section 21 is disposed horizontally on a surface an end of the second structural section 22 which is distal to the first structural section 21 is at a higher height from the surface than another end which is adjacent to the first structural section 21.

A grip 23 is coupled to the first structural section 21. The second structural section 22 and the grip 23 are on opposite ends of the first structural section 21. The grip 23 is of made of a material which allows a user to grasp comfortably and which has a less hardness than a hardness of the body 20.

Each of the third and fourth lateral sides 223 is tapered and which includes a wider end adjacent to the first structural section 21 and a narrower end distal to the first structural section 21. Each of the third and fourth lateral sides 223 protrudes above the fourth surface 222.

Furthermore, the second structural section 22 includes an inclined surface which inclines from the second surface 212 to the fourth surface 222 and which extends lengthwise along the axis L. Each of the third and fourth lateral sides 223 protrudes above the inclined surface.

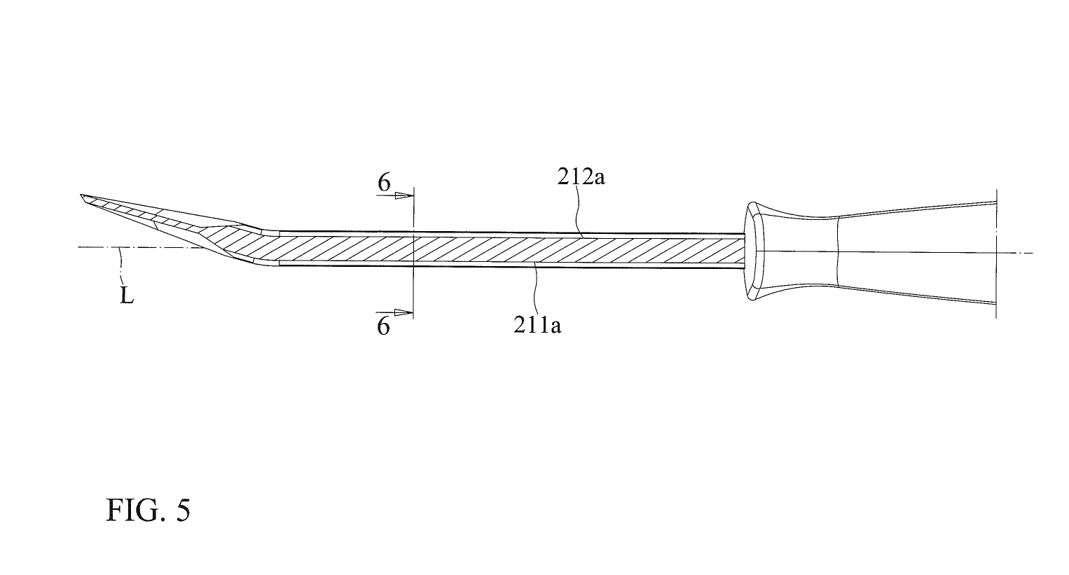

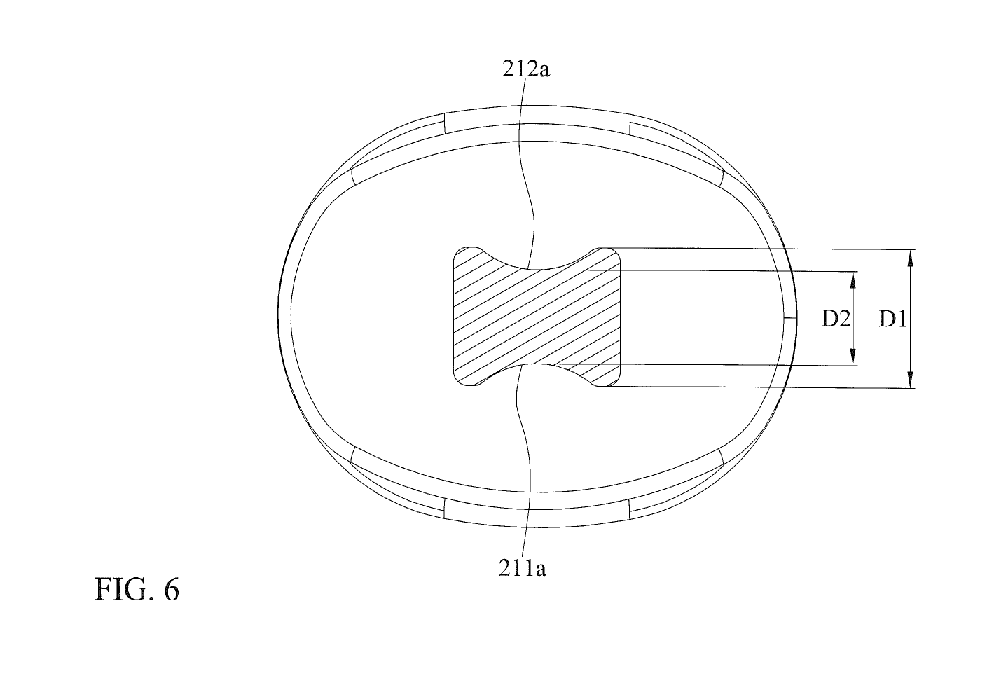

FIGS. 5 and 6 show a prying device in accordance with a second embodiment of the present invention, and the same numbers are used to correlate similar components of the first embodiment, but bearing a letter a. The second embodiment differentiates from the first embodiment in that a first surface 211a also curves into a concave shape in a direction transverse to the axis L. Furthermore, the first surface 211a and a second surface 212a are spaced apart from one another in a thickness of a first structural section, the first structural section has a first thickness D1 defining a maximum thickness thereof and a second thickness D2 defining a minimum thickness thereof respectively, and the second thickness D2 is less than 0.8 times of the first thickness D1. Moreover, the second thickness D2 is greater than 0.6 times of the first thickness D1.

In view of the forgoing, the prying devices are built to withstand high stress tensile working loads during prying operations and, accordingly, the second surfaces 212 and 212a have concave shapes, and the first and third surfaces 211, 211a and 221 are juxtaposed, as well as the second and fourth surfaces 212, 212a, and 222 are juxtaposed.

The foregoing is merely illustrative of the principles of this invention and various modifications can be made by those skilled in the art without departing from the scope and spirit of the invention.

What is claimed is:

1. A prying device comprising:
a body being a one-piece structure and including a first structural section and a second structural section, with the second structural section connected to the first structural section axially along an axis, with the first structural section having a longitudinal length determining a lever arm length of the prying device, with the second structural section adapted to insert underneath an object to be pried by the prying device, with the first structural section including first and second surfaces and first and second lateral sides extending lengthwise along the axis, with the first and second surfaces disposed oppositely, with the first and second lateral sides disposed oppositely and each extending from the first surface to the second surface, with the second surface curving into a concave shape in a direction transverse to the axis, with the second structural section including third and fourth surfaces and third and fourth lateral sides extending lengthwise along the axis, with the third and fourth surfaces disposed oppositely, and with the third and fourth lateral sides disposed oppositely and each extending from the third surface to the fourth surface, and wherein the first and third surfaces are juxtaposed and on the same side of the body, and wherein the second and fourth surfaces are juxtaposed and on the same side of the body.

2. The prying device as claimed in claim 1, wherein each of the third and fourth lateral sides is tapered and which includes a wider end adjacent to the first structural section and a narrower end distal to the first structural section.

3. The prying device as claimed in claim 2, wherein each of the third and fourth lateral sides protrudes above the fourth surface.

4. The prying device as claimed in claim 3, wherein the second structural section includes an inclined surface which inclines from the second surface to the fourth surface and which extends lengthwise along the axis.

5. The prying device as claimed in claim 4, wherein each of the third and fourth lateral sides protrudes above the inclined surface.

6. The prying device as claimed in claim 2, wherein the body includes a bend between the first and second structural sections, and wherein when the first structural section is disposed horizontally on a surface an end of the second structural section which is distal to the first structural section is at a higher height from the surface than another end which is adjacent to the first structural section.

7. The prying device as claimed in claim 4, wherein the body includes a bend between the first and second structural sections, and wherein when the first structural section is disposed horizontally on a surface an end of the second structural section which is distal to the first structural section is at a higher height from the surface than another end which is adjacent to the first structural section.

8. The prying device as claimed in claim 1, wherein the first surface is a flat level surface, wherein the first and second surfaces are spaced apart from one another in a thickness of the first structural section, wherein the first structural section has a first thickness defining a maximum thickness thereof and a second thickness defining a minimum thickness thereof respectively, and wherein the second thickness is less than 0.9 times of the first thickness.

9. The prying device as claimed in claim 8, wherein the second thickness is greater than 0.75 times of the first thickness.

10. The prying device as claimed in claim 1, wherein the first surface curves into a concave shape in a direction transverse to the axis, wherein the first and second surfaces are spaced apart from one another in a thickness of the first structural section, wherein the first structural section has a first thickness defining a maximum thickness thereof and a second thickness defining a minimum thickness thereof respectively, and wherein the second thickness is less than 0.8 times of the first thickness.

11. The prying device as claimed in claim 10, wherein the second thickness is greater than 0.6 times of the first thickness.

12. The prying device as claimed in claim 1, wherein the first and second lateral sides are flat level surfaces.

13. The prying device as claimed in claim 7, wherein the first structural section is quadrilateral in cross-section.

14. The prying device as claimed in claim 7 further comprising a grip coupled to the first structural section, and wherein the second structural section and the grip are on opposite ends of the first structural section.

15. The prying device as claimed in claim 7, wherein the first surface is a flat level surface, wherein the first and second surfaces are spaced apart from one another in a thickness of the first structural section, wherein the first structural section has a first thickness defining a maximum thickness thereof and a second thickness defining a minimum thickness thereof respectively, and wherein the second thickness is less than 0.9 times of the first thickness.

16. The prying device as claimed in claim 15, wherein the second thickness is greater than 0.75 times of the first thickness.

17. The prying device as claimed in claim 7, wherein the first surface curves into a concave shape in a direction transverse to the axis, wherein the first and second surfaces are spaced apart from one another in a thickness of the first structural section, wherein the first structural section has a first thickness defining a maximum thickness thereof and a second thickness defining a minimum thickness thereof respectively, and wherein the second thickness is less than 0.8 times of the first thickness.

18. The prying device as claimed in claim 17, wherein the second thickness is greater than 0.6 times of the first thickness.

19. The prying device as claimed in claim 14, wherein the grip is of made of a material which allows a user to grasp comfortably and which has a less hardness than a hardness of the body.
